(19) United States
(12) Patent Application Publication
(10) Pub. No.: US 2004/0098403 A1
(43) Pub. Date: May 20, 2004

(54) Method and apparatus for displaying real-time status of product availability, orders, and sales revenue

(76) Inventors: Aman Gupta, Milwaukee, WI (US); Amit Maheshwari, Brookline, MA (US); James A. Yenerich, Pewaukee, WI (US)

Correspondence Address: ZIOLKOWSKI PATENT SOLUTIONS GROUP, LLC (GEMS), 14135 NORTH CEDARBURG ROAD, MEQUON, WI, 53097, US

(21) Appl. No.: 10/633,290

(22) Filed: Aug. 1, 2003

Related U.S. Application Data
(63) Continuation of application No. 09/748,520, filed on Dec. 22, 2000.

(51) Int. Cl. G06F 17/00

(52) U.S. Cl. 707/102

(57) ABSTRACT

The present invention discloses a method and apparatus for displaying real-time status of product availability, orders, and sales revenue. The present invention includes querying a database at regular recurring time intervals for information regarding the date a product will be ready for shipment. The number of days between the current date and the date when each product will be ready for shipment is calculated and is displayed along with the date each product will be ready for shipment. The present invention further includes one or more computer programs that when executed by one or more processors instructs the one or more processors to display real-time status of product availability. The program instructions further include populating the database with data to include a date when each product will be available for shipment.

### BACKGROUND OF THE INVENTION

The present invention relates generally to electronically reporting the status of product availability, number of orders, and current sales revenue. The information is automatically tallied and reported via a computer configured to provide up-to-date, on demand information at any time.

Accurate reporting of product availability, orders and sales revenue is a key to the success and longevity of any business. It provides raw indicators of the current business activity and status. Without it, a business would encounter increased difficulty in the ability to plan for future activity. The mistakes may be related to a plethora of actors, including untimely ordering of parts, delayed or missed delivery dates, and inaccurate reporting of income from sales. With mistakes comes the loss of business efficiency and loss of profits, and ultimately the business' demise.

While current database technology does provide record keeping and tallying capabilities, the known technology is hampered by limited reporting options. Commercial database software can provide a place where business records are kept and continuously updated by users. Custom reports of the information a user needs at a specific time can be created and run when necessary. However, there is generally no provision for providing updated electronically available reports in real-time.

It would therefore be highly desirable to design an automated reporting tool that can provide accurate, up-to-date information automatically and in real-time.

### SUMMARY OF THE INVENTION

The present invention overcomes the aforementioned drawbacks by providing a system and method for automatically reporting the current availability of a product or service by querying a database containing the relevant information and creating a report that is easily accessed via computer.

In one aspect of the invention, a method for displaying real-time status of product availability is disclosed. The method includes querying a database at regular recurring time intervals for information regarding the date each product will be ready for shipment. The method further includes counting the number of days between the current date and the date when each product will be ready for shipment. The method also includes displaying the number of days between the current date and the date each product will be ready for shipment.

In another aspect of the invention, a computer-readable medium having stored thereon one or more computer programs that, when executed by one or more processors, causes the one or more processors to display the real-time status of product availability is disclosed. The programmed instructions include populating a database with data to include a date when each product of a plurality of products will be available for shipment. The instructions further provide querying the database to obtain the date when each product will be available for shipment, while ignoring those products without a valid date record. The instructions next provide for counting the number of days between the current date and the date when each product will be available for shipment to create a number of days before the product will be available. For the next step, the instructions provide that the number of days before the product will be available is then displayed.

In accordance with yet another aspect of the invention, a computer data signal representing a sequence of instructions that, when executed by one or more processors, caused the one or more processors to report product availability dates is provided. The signal includes a plurality of instructions, including instructions to maintain a database containing at least a date when each product will be ready for shipment. The signal also provides instructions whereby the dates are obtained periodically from each record of the database while ignoring an entry if the date does not exist. Using that information, the signal further provides instructions to count the number of days between today and the date each product will be available for shipment to create a number of days before the product is available. Additionally the instructions include displaying the corresponding date when the product will be available.

Various other features, objects, and advantages of the present invention are made apparent by the following detailed description and drawings.

### BRIEF DESCRIPTION OF THE DRAWINGS

The drawings illustrate one preferred embodiment presently contemplated for carrying out the invention.

In the drawings:

FIG. 1 is a high-level overview block diagram representing an embodiment of the invention.

FIG. 2 is a flow chart representation of a process to display quality indicators in accordance with one aspect of the invention.

FIG. 3 is a flow chart representation of the availability reporting process in accordance with another aspect of the invention.

FIG. 4 is a flow chart representation of the work in progress table update process in accordance with another aspect of the invention.

FIG. 5 is a flow chart representation of the shipment and promise alert setting and display process in accordance with another aspect of the invention.

FIG. 6 is a flow chart representation of the process to display orders and revenue in accordance with another aspect of the invention.

FIG. 7 is a representation of the Z-value graphic indicator in accordance with another aspect of the invention.

### DETAILED DESCRIPTION OF THE PREFERRED EMBODIMENT

In a preferred embodiment of the present invention, a program is designed to augment a commercially available database program. Specifically, it is designed as a separate program that works with data in the database. The program provides real-time, or near real-time reporting capabilities that are not available to users of the commercially available database. Other embodiments of the invention may use different hardware and/or software manifestations to embody the invention in accordance with their particular design.

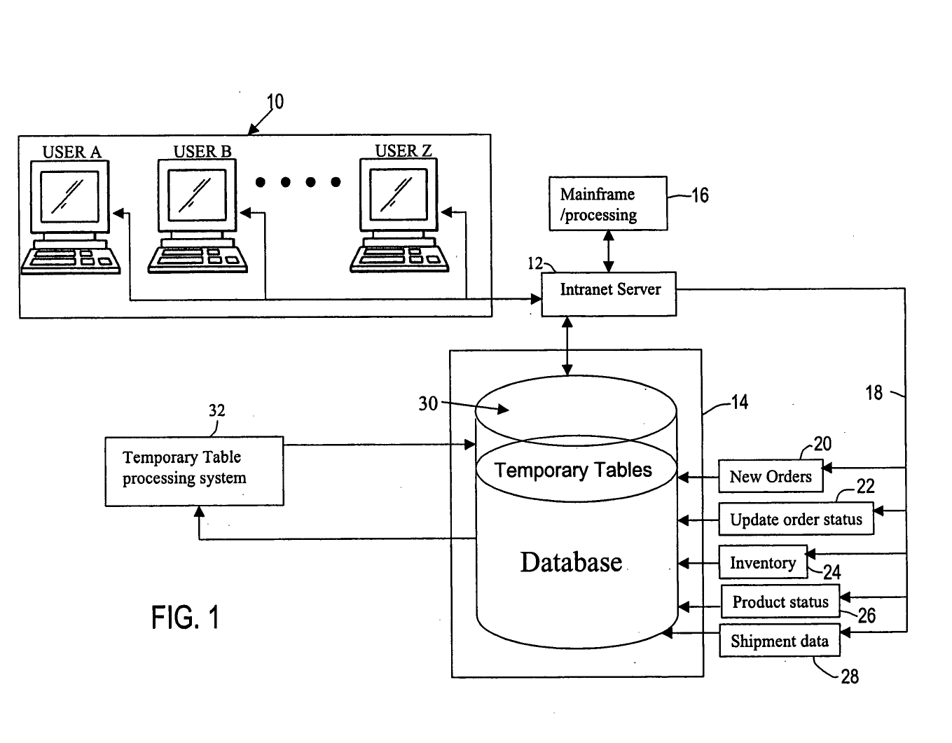

Referring to FIG. 1, an overview diagram of a reporting system is shown which includes a plurality of user stations 10 such as User A, User B through User Z. These user stations 10 represent any number of users on a network at any time. The user stations 10 are connected to an Intranet server 12. This can be through direct communication, a local area network, or from another network like an intranet or the Internet. It may also include user stations 10 connected via a variety of other networking connections, including wireless connections. The Internet server 12 is in communication with database 14, which may be on another computer network. The Intranet server 12 is also communicatively connected to a mainframe/processing section 16. The Mainframe/Processing section 16 processes data from database 14 based on user requests and completes various reports and provides the reports to the user stations 10.

Database 14 contains data on orders, availability (when products will be available for shipping), requested shipping dates, actual shipping dates, promised shipping dates, revenue per order, and various other product and sales information. All of the information is constantly updated at the user stations 10, and is communicated through the Intranet server 12. Some of the users may update the information and some may merely be accessing the database for information. The boxes 20-28 in FIG. 1 show the input of this information into the database 14, indicated by data input 18. The data includes new orders 20, update order status 22, current inventory 24, product status 26, and shipment data 28.

The database 14 has the ability to reserve areas for computational results known as temporary tables 30. The tables contain the latest totals programmed to be stored therein that can be readily accessed by the users at user stations 10. It is temporary in that the temporary table processing system 32 repeatedly updates the temporary tables 30. When the data in the database 14 changes, the inputs to the temporary table processing system 32 are modified to update the information in the temporary tables 30 with new totals. In the preferred embodiment, the temporary table processing system 32 updates the data in the temporary tables 30 every 60 minutes, but the time interval can be set by the programmer. Depending on needs, the update is performed based on such factors as product turn over, product manufacture time, number of orders taken per interval, and so on. The update should be performed often enough so that users acquire real-time data based on these factors.

The preferred embodiment shown in FIG. 1 contemplates a manufacturing facility that has a number of products in various stages of completion, or a re-manufacturing facility with the same traits. Such a facility may have a system as represented by FIG. 1 merely to report the status to internal users. Additionally, an organization with these capabilities may want to make the information available to field sales personal, or even directly to potential customers.

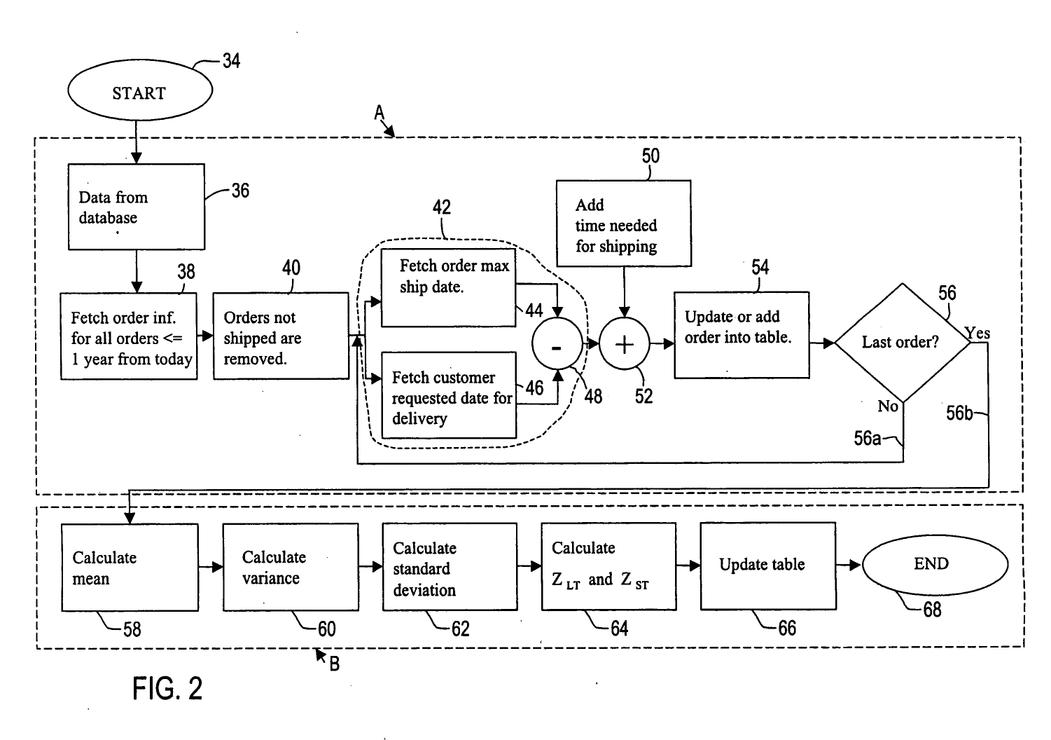

FIG. 2 is a representation of a preferred embodiment for the statistical prediction of future performance process. In general, a process can be measured for performance if certain specification limits are set to measure it. To do so, the system must determine how many times the process produces a defect, or an output, that does not conform to the specifications that were set, as compared to how many times it produces a non-defect, or a successful output, within a given number of opportunities. In this manner, it is possible statistically to predict the output of a process by sampling performance of the process and analyzing that data. The process can then be assessed and adjusted to improve future performance as against the specification limits.

Referring to FIG. 2, the flowchart provides a description of a preferred process for creating the statistical calculation to indicate quality. Overall, FIG. 2 is divided into two separate parts. Part A describes updating the temporary tables 30 in the database 14, and Part B describes the process flow of the statistical calculation.

Referring to FIG. 2, Part A, in more detail, upon initialization of the updating process 34, data from the database 36 is obtained by a fetch order for information 38. This is sometimes referred to as querying the database. In this embodiment, the data obtained is only for the orders that have occurred within the past year for statistical purposes. However, any time period can be chose based on design choice. The next step is where orders that have not been shipped are removed from consideration 40 because this portion of the system is only concerned with shipped orders. Next, the initial calculation 42 is performed which requires fetching the maximum ship date from that order at 44 and fetching the customer's requested date for delivery 46. In this embodiment, each order may have more than one product, and the maximum ship date referred to in 44 is the date that the last product on the order was actually shipped. The customer requested date for delivery 46 is subtracted 48 from the maximum ship date 44. At this point, the process adds 52 the time needed for shipping the product to the customer 50 to the difference between the maximum ship date and the customer's requested date for delivery providing the result to update the table 54. Updating the information that is already in the table or providing a new entry then modifies the table. The process then checks whether the last order was processed 56, and if not 56a, the process returns to the initial calculation step 42 where the previously-described process is repeated on the next order entry. If the order is the last 56b, then the process continues to the statistical calculation section of part B. It is important to note that the invention anticipates the use of any number of statistical calculations to predict the capability of a process, both known and as yet unknown. The preferred embodiment uses a value known as the “Z” score to provide information about process capability.

To calculate the mean 58, the data is added together and divided by the number of entries. In statistical equations the mean is customarily represented by the Greek letter mu (μ). The next act in the process is to calculate the variance 60. As is well known in the art, this is done by subtracting the mean from each entry in the table to determine a deviation for each entry, squaring each deviation, summing the squared deviations and dividing that sum by the number of entries. The Greek letter sigma σ represents variance when shown with an exponent of 2 (i.e., σ²). The next act is to calculate the standard deviation 62. This calculation is also well known in the art, and it is equal to the square root of the variance. The standard deviation is traditionally represented by the Greek letter sigma (σ) with an exponent of 1. The next step is to determine the values for Z long-term and Z short-term 64. In general, Z-scores are well known in the art of statistics. Z long-term (Z_{LT}) is calculated from the standard deviation and the average output of the current process. Used with continuous data, Z_{LT} represents the overall process capability and can be used to determine the probability of out-of-specification parts within the current process. Usually process capability is measured in defective parts per million opportunities, or DPMO.

In the preferred embodiment, the Z score is determined by first setting an upper specification limit (USL) and a lower specification limit (LSL), also referred to as tolerance limits. These limits are designated either arbitrarily, or as a result of researching customer needs, to determine the goals or tolerance of the process. As a measure of quality, any data point that falls outside of the USL and LSL is then considered a defect. The Z long-term (Z_{LT}) value is then calculated by use of the formula:

$${Z}_{L T} = min [ \frac{USL - μ}{σ} , \frac{μ - LSL}{σ} ] ,$$

where USL is the preset upper specification limit, LSL is the preset lower specification limit, μ is the mean, and σ is the standard deviation. In the preferred embodiment, the minimum result of the two expressions is taken as the measure of performance for the process. The user may then interpret the result. Interpretation may include applying the result to a normal or other distribution to determine the percentage of defects produced with a given number of opportunities. It is contemplated and believed within the scope of the present invention that interpretation of the results to determine DPMO could be easily automated as well. Z values can also be calculated in other ways; for example, both expressions can be used in some calculations instead of using the minimum of the two.

Continuing with the preferred embodiment, the Z_{LT} value is then used to determine the Z short term (Z_{ST}) value by using the formula: Z_{ST}=Z_{LT}+1.5. This is an estimation of performance based upon the idea that the performance of a process will deteriorate over time. Thus the short-term performance represented by the Z score should be better than the long-term performance, and adding 1.5 to the long-term Z score estimates the short-term Z score. The Z scores are then moved to the update table 66 where they can be called for display. In the preferred embodiment, Z short term (Z_{ST}) is the standard scale for reporting performance quality based on a target goal of 6 Sigma (If Z_{ST}=6 then DPMO=3.4). At this point the process ends 68.

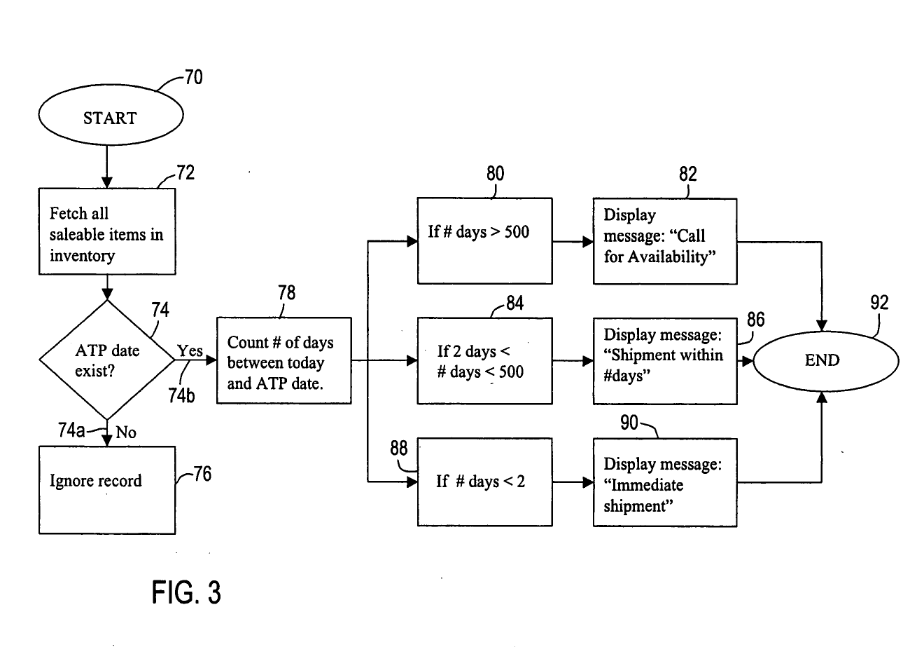

FIG. 3 is a flow diagram of the process of a preferred embodiment for displaying inventory availability. The process begins at the start step 70 and the first step is to fetch all saleable items in the inventory 72 from the database. The program then must determine whether each record contains a date indicative of whether the product is available to ship, referred to as an available to promise (ATP) date 74. If a particular record does not have an ATP date 74a, the record is ignored 76. If it does have an ATP date 74b, then the process next counts the number of days between a current date (i.e., typically today) and the ATP date at 78. The resulting number is then provided to the next part of the process to determine which of the messages is appropriate to display for this record. If the number of days between the current date and the ATP date is greater than 500 days 80, then the message “Call for Availability” is displayed 82. If the number of days between the current date and the ATP date is greater than 2 days and less than or equal to 500 days 84, then the message “Shipment within number where number is the number of days between the current date today and the ATP date days” 86 is displayed. On the other hand, if the number of days between the current date today and the ATP date is less than or equal to two 88, then the message “Immediate Shipment” is displayed 90. Once the appropriate message is displayed, the process ends for that entry at 92.

In one aspect of the invention, a method for displaying real-time status of product availability is disclosed. Data concerning orders, inventory and revenue details are stored on a database that is continuously updated with the current business activities. The method includes querying the database at regular time intervals for information regarding the date each product will be ready for shipment. The time interval can be adjusted to the situation. If the data changes little throughout the day, the updating process can be every hour, for example. If the data changes constantly, the interval can reflect the real-time nature of the information. Returning to the method, it further includes counting the number of days between the current date and the date when each product will be ready for shipment. The method also includes displaying the number of days between the current date and the date each product will be ready for shipment.

In another aspect of the invention, a computer-readable medium having stored thereon one or more computer programs is disclosed. The programmed instructions include a database with data to include a date when each product will be available for shipment, for a plurality of products. The database is kept current by populating the database with information reflecting business activity. The programmed instructions provide that the database is queried to obtain the date when each product will be available for shipment. If the entry has no valid date record, the record is ignored. The instructions next provide for counting the number of days between the current date and the date when each product will be available for shipment to determine the number of days before the product will be available. For the next step, the instructions provide that the number of days before the product will be available is then displayed. In this way, the sales people or customer service representatives can provide accurate information about pending shipments for products being produced.

In accordance with yet another aspect of the invention, a computer data signal represents a sequence of instructions that, when executed by one or more processors, caused the one or more processors to report product availability dates. The signal includes a plurality of instructions, including instructions to maintain a database containing at least a date when each product will be ready for shipment. The signal also provides instructions to obtain the dates periodically from each record of the database while ignoring an entry if the date does not exist. The signal further provides instructions to use the obtained information to count the number of days between today and the date each product will be available for shipment. Additionally the signal provides instructions for applying the number of days between today and the date each product will be available for shipment to a calendar starting from the current date, and then displaying the corresponding date when the product will be available. The result is a display of the date when a product is expected to be available for shipment.

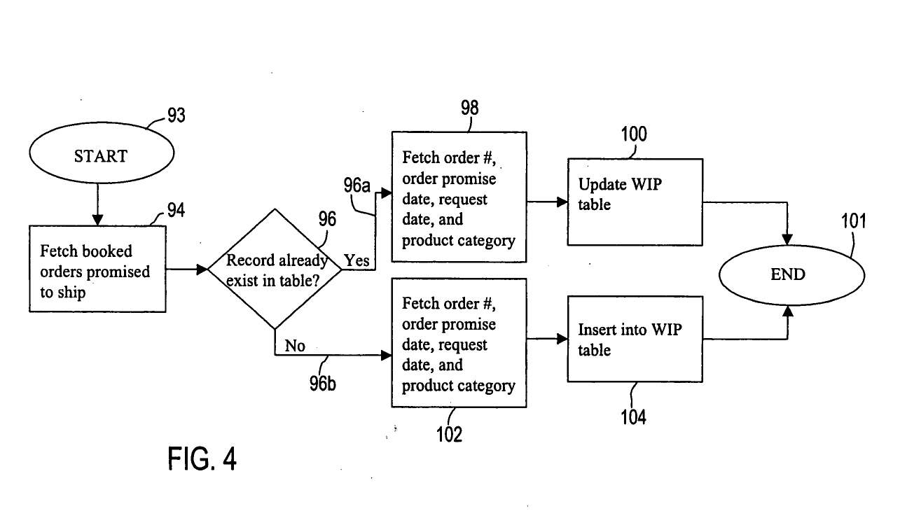

FIG. 4 is a flow diagram representing the work in progress (WIP) table update process for one preferred embodiment. The process updates the WIP table that is in the temporary tables of the database to ensure the data displayed is the most current available. The process begins after initialization 93 by fetching the booked orders that have been promised a shipping date 94. The system then determines whether the record already exists in the current WIP table 96. If the record already exists 96a, the order number, order promise date, request date, and the product category are fetched 98, and they are used to update the current entry in the WIP table 100. This portion of the process is then complete at 101. If the record does not exist 96b, the order number, order promise date, request date, and the product category are fetched 102, and are used to create a new entry in the WIP table 104. This portion of the process is then complete at 101. The entire process repeats until all the entries for the WIP table have been either updated or created.

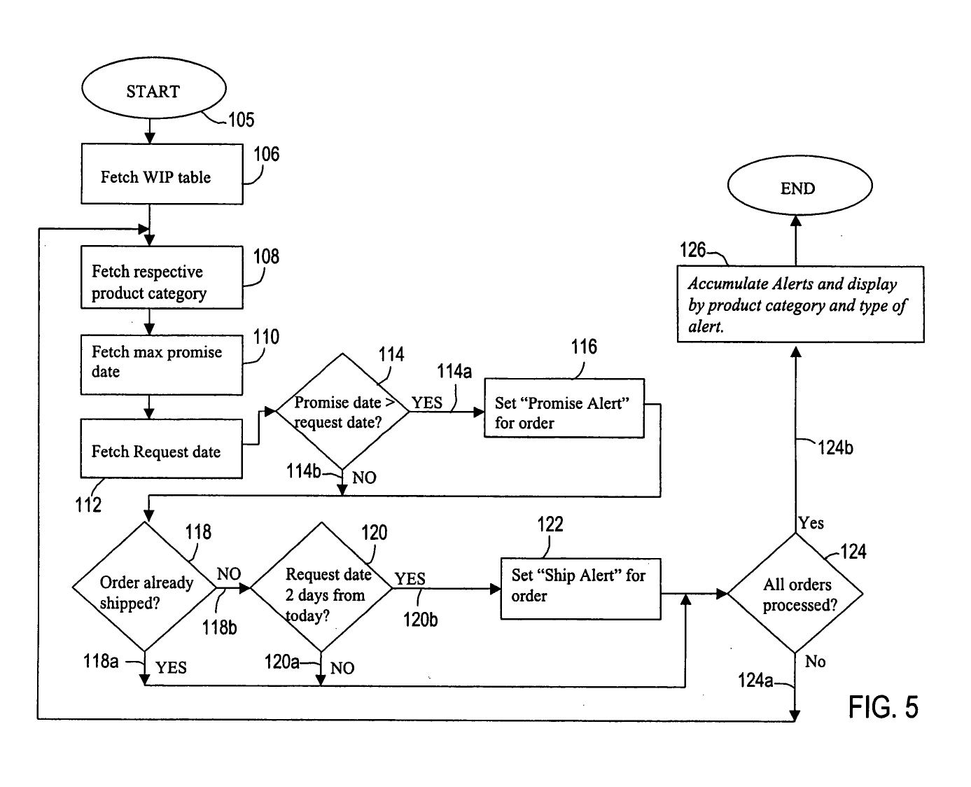

FIG. 5 is a flow chart representing the alert setting and display process. The system provides for both proactive and reactive alerts, allowing use of the information to repair problems in the shipping process. The word “proactive” is meant to show that an alert may be set while there is still time to rectify a possible problem in the process, in this case, shipping. The proactive alert allows the process owners to make adjustments or take special action in order to avoid a late shipment. The reactive alert may not provide the same information, but the information is still useful to ensure that recognized problems do not occur.

Continuing with FIG. 5, the alert setting and display process begins after an initialization 105, by fetching the WIP table 106 and then processing with each order in the WIP table. The program fetches the respective product category 108 and then the maximum promise date 110. The maximum promise date is the latest date promised to the customer for shipment. The request date is then fetched 112, and then the process determines whether the promise date is after the request date 114. If the promise date is later than the request date 114a, then a “Promise Alert” is set and displayed for that order 116, and the process moves to the order already shipped question 118. If the maximum promise date is prior to the request date 114b, then the process skips the promise alert step 116 and moves directly to the order already shipped 118 determination. If the order has already been shipped 118a, the process moves directly to check to see if all the orders have been processed at 124. If not 118b, the process then determines whether the request date is within a preset number of days from a current data 120. In this embodiment, the preset number of days is two. If the request date is not within two days of the current date 120a then the process moves to check if another order must be processed at 124. If the request date is within two days of the current date 120b, then the “Ship Alert” is set and displayed 122, and the process moves to check if all the orders have been processed 124. The process then repeats for all orders 124, 124a. Once all of the orders have been processed 124b, the alerts are accumulated and displayed for the individual orders sorted by product category and type of alert 126. The alerts provide opportunities for management to fix problems before they happen.

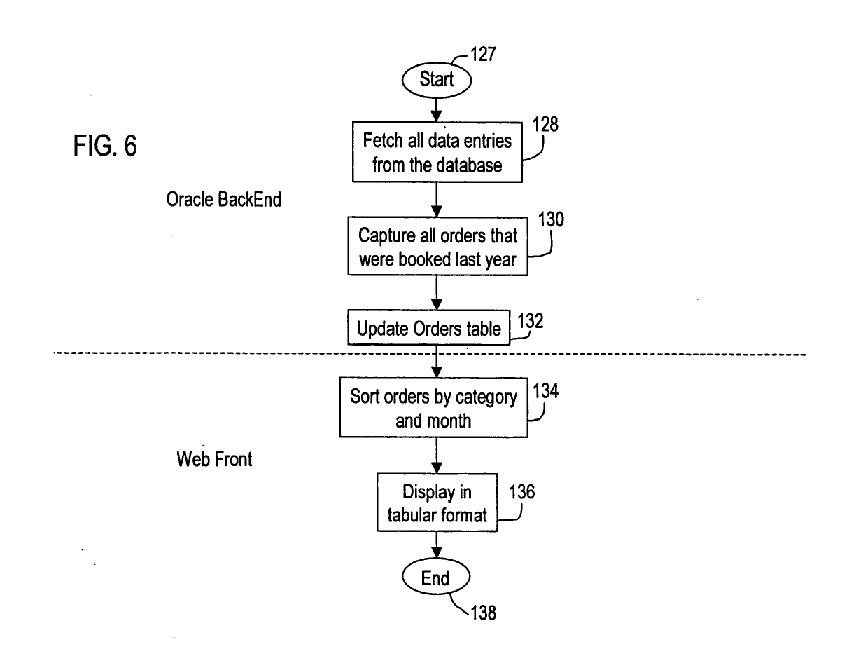

FIG. 6 is a representation of the process used to display the orders and revenue for a past period of time. The process is initiated automatically when the information is requested, or on a regular pre-programmed basis 127. In a preferred embodiment, all of the order information, including revenue for each order, is retrieved from the database 128. The program then captures all the orders 130 in a previous period of time, in this example, a last year. The Orders table is then updated 132 with the data from the capture 130. At this point the orders in the table are sorted by month and category 134. The last step provides that the orders, order totals, revenue and revenue totals are displayed in tabular format 136 for viewing in an easily understandable way. After all the orders are displayed the process is completed at 138.

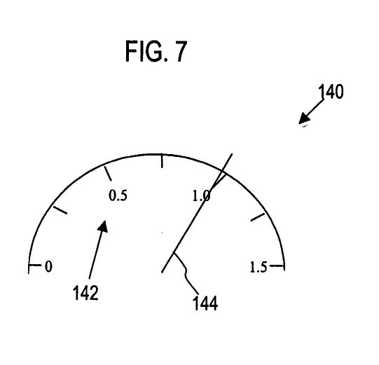

FIG. 7 is a representation of the Z-value graphic indicator in accordance with another aspect of the invention. The preferred embodiment provides an indicator written in Java. The ranges of values on the scale change automatically to best reflect the value to be indicated, and the needle indicates the value of the current calculation.

Each of the processes just described can be used alone, or in conjunction with each other in various combinations. In one preferred embodiment, the reports are displayed on a number of web pages within an intranet system. It is automatically updated and the information is available 24 hours a day on an as-needed, on-demand basis.

The present invention has been described in terms of the preferred embodiment. While the preferred embodiment uses computers that are communicating through some form of a network, it is understood that other embodiments of the invention may involve the use of different technologies. It is recognized that equivalents, alternatives and modifications that are different from the preferred embodiment exist, and they are within the scope of the appending claims.

1. A method for displaying real-time status of product availability comprising:
automatically querying a database at regular time intervals for a date when each product will be ready for shipment for a plurality of products, and if the date does not exist, skipping that product, otherwise;
for each product, counting a number of days between a current date and the date when the product will be ready for shipment to create a number of days before the product is available; and
displaying when the product is available for shipment.

2. The method of claim 1 wherein the step of querying also includes querying the database for a number of orders, a product category for each order, and sales revenue for each order, and further comprises:
adding the number of orders for each product category to create a sum of the number of orders for each product category; and
adding the sales revenue from each order in each product category to create a sum of the total revenue for each product category;
displaying the sum of the number of orders for each product category; and
displaying the sum of the total revenue for each product category.

3. The method of claim 1 wherein the displaying step includes displaying the number of days until the product is available for shipment.

4. The method of claim 1 further comprising creating a plurality of display categories, wherein each display category depends on the number of days before the product is available.

5. The method of claim 4 wherein the plurality of display categories includes:
displaying a first user-defined message if the number of days before the product is available is greater than a user-defined number; and
displaying a second user-defined message if the number of days before the product is available is less than a user-defined number.

6. The method of claim 5 wherein the first user-defined message is “call for availability” and the second user-defined message is “ready for immediate shipment.”

7. The method of claim 1 wherein the step of automatically querying is performed in real-time.

8. A computer-readable medium having stored thereon one or more computer programs that, when executed by one or more computers, causes the one or more computers to:
populate a database with data to include a date when each product will be available for shipment for a plurality of products;
periodically query the database to obtain the date for the products while ignoring those products that do not have a valid shipment date;
count a number of days for each product between a current date and the date when the product will be ready for shipment to create a number of days before the product is available; and
display the number of days before the product is available.

9. The computer-readable medium of claim 8 where the computer program further causes the one or more computers to:
apply the number of days before the product is available to a calendar starting from the current date; and
display a date when the product will be available.

10. The computer-readable medium of claim 8 where the computer program further causes the one or more computers to:
populate the database with data to include number of orders, a product category for each order, and sales revenue for each order;
add the number of orders for each product category together to create a sum of the number of orders for each product category;
add the sales revenue for the number of orders in each product category together to create a sum of the total revenue for each product category; and
display the sum of the number of orders for each product category and the sum of the total revenue for each product category.

11. The computer-readable medium of claim 8 where the computer program further causes the one or more computers to:
create a plurality of categories for display, wherein determination of a category depends on the number of days before the product is available.

12. The computer-readable medium of claim 11 wherein the plurality of categories includes a first category for orders including orders where the number of days before the product is available is greater than a user-defined number, and a second category for orders including orders where the number of days before the product is available is less than a user-defined number, wherein the computer program further causes the one or more computers to:
display a first user-defined message for each order in the first category; and
display a second user-defined message for each order in the second category.

13. The computer-readable medium of claim 12 wherein the first user-defined message is “call for availability” and the second user-defined message is “ready for immediate shipment.”

14. The computer-readable medium of claim 11 wherein the plurality of categories includes a category for orders where the number of days before the product is available is within a user-defined range of values, wherein the computer program further causes the one or more computers to:
display a user-defined message for each order within the category.

15. The computer-readable medium of claim 8 wherein the periodic query of the database is performed at least every time a request for information is made.

16. A computer data signal representing a sequence of instructions that, when executed by one or more processors, cause the one or more processors to:
maintain a database containing at least a date when each product will be ready for shipment,
periodically obtain from the database the date when each product will be ready for shipment while ignoring an entry if such date does not exist;
count a number of days between today and the date each product will be ready for shipment to create a number of days before the product is available; and
display the corresponding date when the product will be available.

17. The computer data signal of claim 16 further causing the one or more processors to:
apply the number of days before the product is available to a calendar starting from the current date; and
display the number of days before the product is available.

18. The computer data signal of claim 16 further causing the one or more processors to:
display a first user-defined message if the number of days before the product is available is greater than a user-defined number; and
display a second user-defined message if the number of days before the product is available is less than a user-defined number.

19. The computer data signal of claim 16 wherein the one or more processors periodically obtains data every 0 to 60 seconds.

20. The computer data signal of claim 16 wherein the data is obtained at intervals greater than once a minute.

21. The computer data signal of claim 16 wherein the signal obtains data every time information is requested.
